(19) United States
(12) Patent Application Publication
(10) Pub. No.: US 2005/0140692 A1
(43) Pub. Date: Jun. 30, 2005

(54) Interoperability between immediate-mode and compositional mode windows

(75) Inventors: Gregory D. Swedberg, Bellevue, WA (US); Mohamed A.M. Sadek, Kirkland, WA (US); Leonardo E. Blanco, Redmond, WA (US); Kevin T. Gallo, Woodinville, WA (US); Joseph S. Beda, Seattle, WA (US); Pravin K. Santiago, Bellevue, WA (US); Hirofumi Yamamoto, Bellevue, WA (US); Andrei Baioura, Bellevue, WA (US); Sriram Subramanian, Kirkland, WA (US)

Correspondence Address: LEE & HAYES PLLC, 421 W RIVERSIDE AVENUE SUITE 500, SPOKANE, WA, 99201, US

(73) Assignee: Microsoft Corporation

(21) Appl. No.: 10/749,125

(22) Filed: Dec. 30, 2003

(51) Int. Cl. G09G 5/02; G09G 5/00

(52) U.S. Cl. 345/600; 345/3.3

(57) ABSTRACT

Described are mechanisms and techniques for providing interoperability between two different graphics technologies. An application includes windows of two types, a legacy type and a new type. A graphics system includes components that support each of the two types. Interoperability is achieved by creating legacy structures associated with any windows of the new type. A mapping is created that associates the legacy structures with the windows of the new type. Rendering of legacy windows is performed by a first graphics technology, and rendering of new windows is performed by a second graphics technology. The distinction between the two types of windows is noted by the existence of the legacy structures.

### TECHNICAL FIELD

This application relates generally to the display of information in a computing system, and more specifically to making enhanced functionality available to legacy applications.

### BACKGROUND OF THE INVENTION

Software programs today typically include many visual representations of data. In most cases, these visual representations are rendered in what are commonly referred to as “windows.” A program executing on a computer may use very many windows in the performance of its duties. In addition, what the layperson thinks of as a single window may in fact be several windows from the perspective of the host computing system. For example, a main window displayed on screen may include an image, a group of options, and some buttons. From the perspective of the computing system, each of those components may itself be a window. In common terminology, the main window is called the “parent window” and each sub-window is called a “child window.” Child windows and themselves have children, which would then be grandchildren of the parent window.

In the past, a computing system would display windows as fixed, rectangular shapes. Applications developed with that technology had limited capability to enhance the visual characteristics of windows. As technology evolves, consumers have pushed developers to offer software applications with more functionality and a richer user experience. Consumers are requesting features such as transparent or arbitrarily shaped windows. Unfortunately, there are problems with satisfying the consumers' requests.

When a new display technology is developed that allows enhanced graphical features and capabilities, existing programs become obsolete. The new display technology may alter the way an application interacts with its windows, thereby rendering the new display technology useless to existing applications. Extensive libraries of graphical components have been created that function with the old display technology. New libraries of graphical components will need to be developed to take advantage of the new display technology. However, this cannot happen overnight, and software developers cannot stop delivering applications or devote all their time to creating components based on the new display technology. For at least this reason, developers might be hesitant to move toward the new display technology because they prefer not to lose the use of their existing graphical components. But until enough libraries of graphical components based on the new technology are developed, applications that take full advantage of the new display technology will not be developed. Until now, a solution to this dilemma has eluded software developers.

### SUMMARY OF THE INVENTION

The invention is directed to mechanisms and techniques for providing interoperability between two different graphics technologies. Briefly stated, an application includes windows of two types, a legacy type and a new type. A graphics system includes components that support each of the two types. Interoperability is achieved by creating legacy structures associated with any windows of the new type. A mapping is created that associates the legacy structures with the windows of the new type. Rendering of legacy windows is performed by a first graphics technology, and rendering of new windows is performed by a second graphics technology. The distinction between the two types of windows is noted by the existence of the legacy structures.

### BRIEF DESCRIPTION OF THE DRAWINGS

FIG. 1 is a functional block diagram generally illustrating a computing environment in which a graphics system permits an application to have windows compatible with two different graphics technologies.

FIG. 2 is a functional block diagram illustrating in greater detail the application and the elements of the graphics system introduced by FIG. 1

FIG. 3 is an illustrative screen display of a possible arrangement of window components for the visual output of the application shown in FIG. 1.

FIG. 4 is a logical flow diagram generally illustrating operations performed by a process for creating a top-level window in a mixed-mode system such as that described in connection with FIG. 1.

FIG. 5 is a logical flow diagram generally illustrating operations performed by a process for creating a child window in a mixed-mode system such as that described in connection with FIG. 1.

FIG. 6 is a functional block diagram illustrating an exemplary computing device that may be used in embodiments of the methods and mechanisms described in this document.

### DETAILED DESCRIPTION

The following description sets forth specific embodiments of mechanisms and techniques for providing interoperability between different graphics technologies. More particularly, mechanisms and techniques are described for enabling interoperability between immediate-mode and compositional mode graphics technologies.

Illustrative Mechanisms to Allow Interoperability in Mixed-Mode Applications

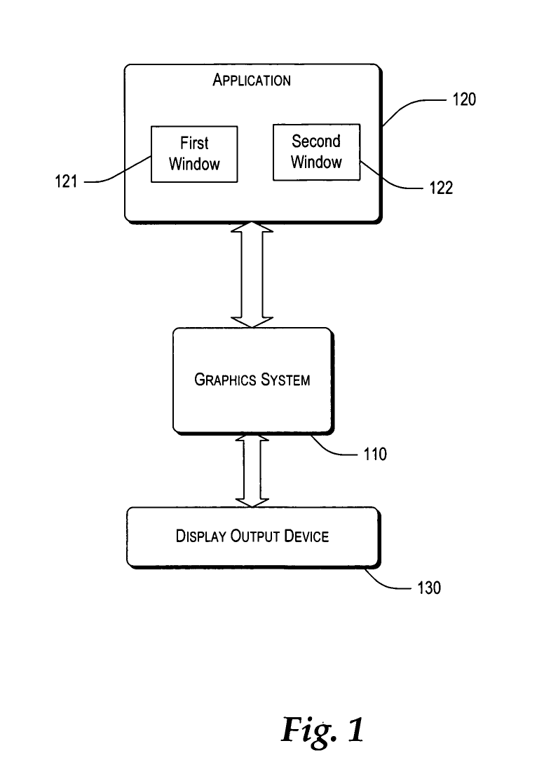

FIG. 1 is a functional overview of a computing environment 100 in which a graphics system 110 permits an application 120 to have different types of windows that are compatible with different graphics technologies. In this example, the application 120 includes windows of two different types—compatible with two different graphics technologies. As will be described more fully below, when executed, the application 120 creates several windows, a top-level window and several child windows. Each of those child windows may also include other child windows.

One or more of the windows (i.e., first window 121) has been created in accordance with one graphics technology. Although the particular type of graphics technology is not determinative of the mechanisms and techniques described here, an “immediate-mode” graphics technology will be described by way of illustration. The immediate-mode graphics technology may be one where any changes to a window are immediately painted directly to the display device. Certain other characteristics may also be associated with the first graphics technology. For instance, the graphics system may operate only in kernel mode, use its own driver model, or be rendered primarily in software. In essence, the immediate-mode graphics system is associated with conventional or older graphics technology, and the particular characteristics described here are by way of example only.

One or more other of the windows (i.e., second window 122) has been created in accordance with a second, newer graphics technology. Although the particular type of second graphics technology is not determinative of the mechanisms and techniques described here, a “compositional-mode” graphics technology will be described by way of illustration. The compositional-mode graphics technology may be a graphics technology that stores descriptions of graphics primitives but may delay actual window painting. The changes to a window are composed off-screen and rendered on demand or in response to some event. In addition, the compositional mode graphics technology may also operate in both kernel and user mode, and could be hardware accelerated or software accelerated. Again, the characteristics of the compositional-mode graphics technology are by way of example only, and could differ in other implementations.

The graphics system 110 includes mechanisms and performs techniques that enable the windows of the different graphics technologies to coexist and even interoperate. The graphics system 110 accepts display output for both types of windows and renders a composite output on a display output device 130. Using this system, application developers can create applications that include both “legacy” windows (based on the immediate-mode graphics technology) and “new” windows (based on the compositional-mode graphics technology). In this way, developers can migrate their applications to the new technology piecemeal, rather than having to completely rewrite large chunks of code or, even worse, forego taking advantage of the newer technology.

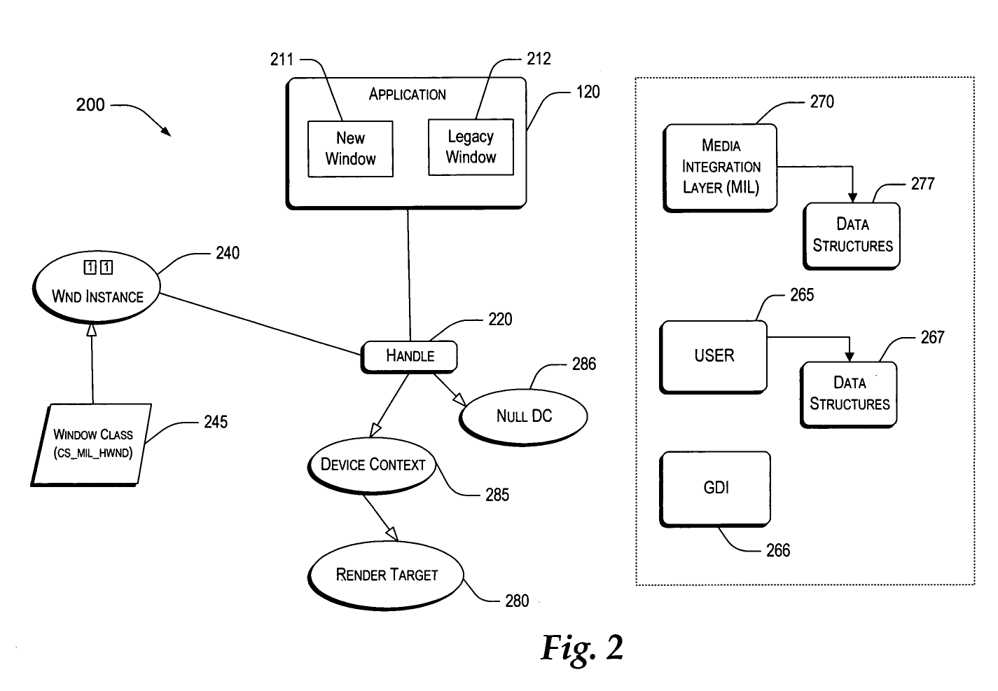

FIG. 2 is a functional block diagram illustrating in greater detail the application 120 and the elements of the graphics system 110 introduced by FIG. 1 above. Referring to FIG. 2, the graphics system 110 includes components that embody two different graphics technologies. At the core of an immediate-mode graphics system is a Graphics Device Interface (GDI) component 266. The GDI component 266 performs operations, including clipping and compositing, necessary to render the display of legacy windows upon instruction by the user component 265. Essentially, the GDI component 266 provides a device-independent platform for programs to supply their visual output. The GDI component 266 may interact with device drivers and the like to make actual visual output appear on a piece of display hardware.

At the core of a compositional-mode graphics system is a Media Integration Layer (MIL) component 270. The MIL component 270 is an advanced display subsystem that provides window display functionality over that made available by traditional or conventional graphics systems, such as the GDI component 266. For instance, the MIL component 270 is configured to allow programs to use arbitrarily sized, shaped, and located window components, whereas the GDI component 266 typically recognizes only static, rectangular windows. Examples of the functionality made available by the MIL component 270 include support for arbitrarily sized, shaped, and located window components, transparency for window components, the ability to add special effects to the window components like rotation and translation, and generally enhanced visual effects for each window component.

A window manager component 265 (commonly referred to as a “user” component) performs several display-related tasks, largely in conjunction with the GDI component 266. More specifically, the user component 265 manages the user interface portion of the computing system, including receiving user input (e.g., mouse clicks and keyboard presses) and dispatching the input to the appropriate window to be handled. Accordingly, the user component 265 maintains data structures 267 that represent the structure and layout of windows associated with each application executing on the computing system. Essentially, the user component 265 is used to manage the windows of conventional (e.g., non MIL-aware) applications.

The MIL component 211 includes sufficient capability to provide window management and rendering without resort to either the user component 265 or the GDI component 266. For instance, the MIL component 211 maintains its own data structures 277 that represent a view of the layout of windows under its control. However, it is envisioned that the MIL component 211 will interact with both the user component 265 and the GDI component 266 to support applications that use both legacy windows and new windows. The MIL component 211 has been constructed to interact with the user component 265 and the GDI component 266 to support legacy windows with a limited number of modifications to either the user component 265 or the GDI component 266, thereby minimizing the potential impact on legacy applications that do not take advantage of the MIL component 211. However, the salient modifications are described here.

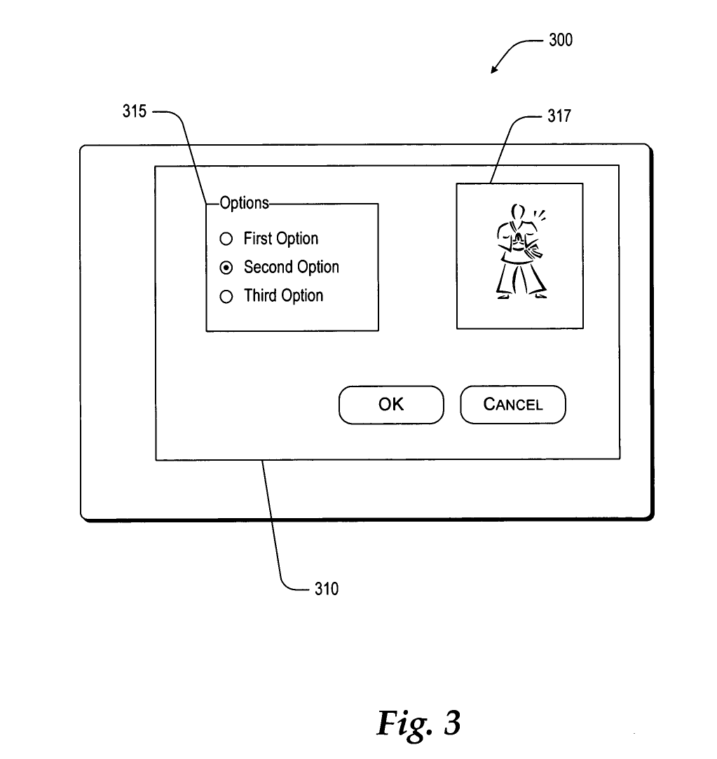

The application 120 may be any software program, but in this particular embodiment is a program constructed to make use of windows for the display of data. In particular, the application 120 includes code that invokes at least two different types of windows: a new window 211 and a legacy window 212. The legacy window 212 is based on the conventional graphics technology (i.e., GDI), and the new window 211 is based on the new technology (i.e., MIL). Although only one new window 211 and one legacy window 212 are shown, it will be appreciated that many such windows, in arbitrary combinations, may be included in the typical software program. One possible example of the visual output is illustrated in FIG. 3, and described below.

A window instance 240 is a construct that represents one of the windows associated with the application 120, such as new window 211. The window instance 240 is based on a window class 245, which contains information like background color, cursor, a window procedure (WndProc) used to process messages for the window, and a variety of flags. A special window class 245 may be used to indicate that its window instances will be owned and managed by the MIL component 270. In this particular implementation, the window class 245 defines certain flags that are used to indicate that the window is a MIL window. In this embodiment, the window instance 240 is associated with the new window 211, and accordingly includes a flag 241 that identifies the window instance 240 as being rendered by the MIL component 270. Another flag 242 may be used to indicate that the window instance 240 is using hardware rendering. This flag is cleared if the parent window is software rendered. Both of these flags may be reported as clear for non MIL windows.

The window instance 240 may be created by calling the user component 265 to create a window based on the identified window class 245. As part of the creation process, the user component 265 creates a window handle 220 associated with the window instance 240. For the purpose of this discussion, a “handle” is any token that a program can use to identify and access an object, such as a window. The window instance 240 may then be manipulated and drawn with 11 reference to its window handle 220. It should be noted that the creation of a window handle 220 would be unnecessary if all the windows of the application 120 were new windows (MIL windows) because the MIL component 270 maintains its own internal data structures to manage its windows. However, in the mixed-mode case, to support interoperability, the user component. 265 is involved in the creation of the windows so that their existence will be noted in the user data structures 267. Thus, it will be appreciated that the window handle 220 for a MIL window is a dummy or mock token used mostly to ensure that the user component 265 is aware of any windows that the MIL component 270 is rendering.

In accordance with conventional graphics technology, when the application 120 draws to an output device, it doesn't output pixels directly to the device. Instead, it draws to a logical “display surface” or render target 280 associated with the window instance 240. The render target 280 is a rectangular set of pixels that holds the rendered output for a window. The render target 280 can reside either in system memory (software target) or video memory (hardware target). Alternatively, the render target 280 can be an object that records commands to render to such a surface for later replay (record target). A record target records rendering commands generated for certain MIL windows. The record target is played back during composition to generate the final output. Even though the target is virtual it still exposes a pixel extent and DPI. A software target resides in system memory and can only be rendered to using a software engine, such as the GDI component 266 or the MIL component 270. Software targets eventually must be copied to hardware targets for display. A hardware target resides in video memory and can only be rendered natively by the MIL component 270. The hardware target is rendered by the MIL composition engine combining the content of any record targets and software targets. Thus, it can be seen that the type of render target used is based largely on whether the window being rendered is a MIL window or a GDI window. Determining the appropriate render target type is discussed in greater detail below.

Access to the render target 280 is achieved by requesting a device context (DC) 285 that represents the render target 280. The device context 285 is a conventional data structure that contains fields describing what the GDI component 266 needs to know about the render target 280, including the physical device with which it is associated and assorted state information. Before it draws a window, the application 120 requests a device context 285 based on the handle 220 associated with the window instance 240. It can then pass that device context 285 to the GDI component 266 each time it calls a GDI output function.

However, in the case where the window is a MIL window, meaning that the render target 280 is controlled by the MIL component 270, the information in the device context 285 is unnecessary. The MIL component 270 maintains the information necessary to render any windows within its control. Accordingly, in this particular implementation, a null device context 286 may be returned. The null device context 286 is a real DC, but any drawing done to it is lost. The null device context 286 is essentially only a place holder that can be used to lookup a MIL “visual,” which is a term used to describe the display construct of a window under control of the MIL component 270. Thus, the window handle 220 essentially serves as the user component's view into the MIL component's data structures. The MIL visual can be looked up in a two-step process, illustrated by the following pseudocode:
HDC hdc;
HWND hwnd;
System_Windows::_Visual *pVisual;
hdc=BeginPaint( );
hwnd=WindowFromDC(hdc);
pVisual=VisualFromHWND(hwnd);

The preceding discussion illustrates a framework within which an application can include both MIL based windows and GDI based windows. Through the use of the null DC 286, and the window handle 220 to the MIL window instance 240, interoperability is achieved for applications that include both windows associated with immediate-mode rendering and compositional-mode rendering. This ability provides software developers a smoother migration path for their applications from an older graphics technology to a newer, more robust graphics technology. In addition, by persisting some of the same mechanisms for accessing windows (e.g., the device context), the development paradigm remains consistent, thereby simplifying the transition to the new graphics technology.

FIG. 3 is an illustrative screen display 300 of a possible arrangement of window components for the visual output of the application 120. In this example, the screen display 300 includes a main window 310 and several child windows, such as a frame 315, and an image 317. The frame 315 encloses three selectable option buttons. Any of the windows illustrated may be either a legacy window or a new window. For example, the image 317 may be a legacy window, while the main window 310 is a new window. In contrast, the main window 310 may be a legacy window, while the frame 315 or the image 317 are new windows.

Illustrative Techniques for Interoperability in Mixed-Mode Applications

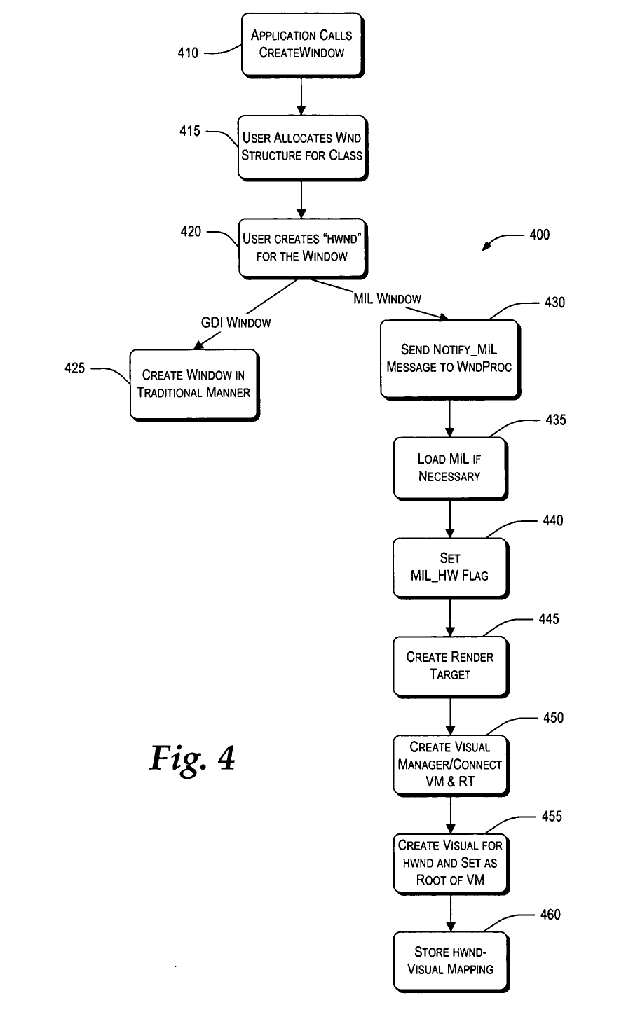

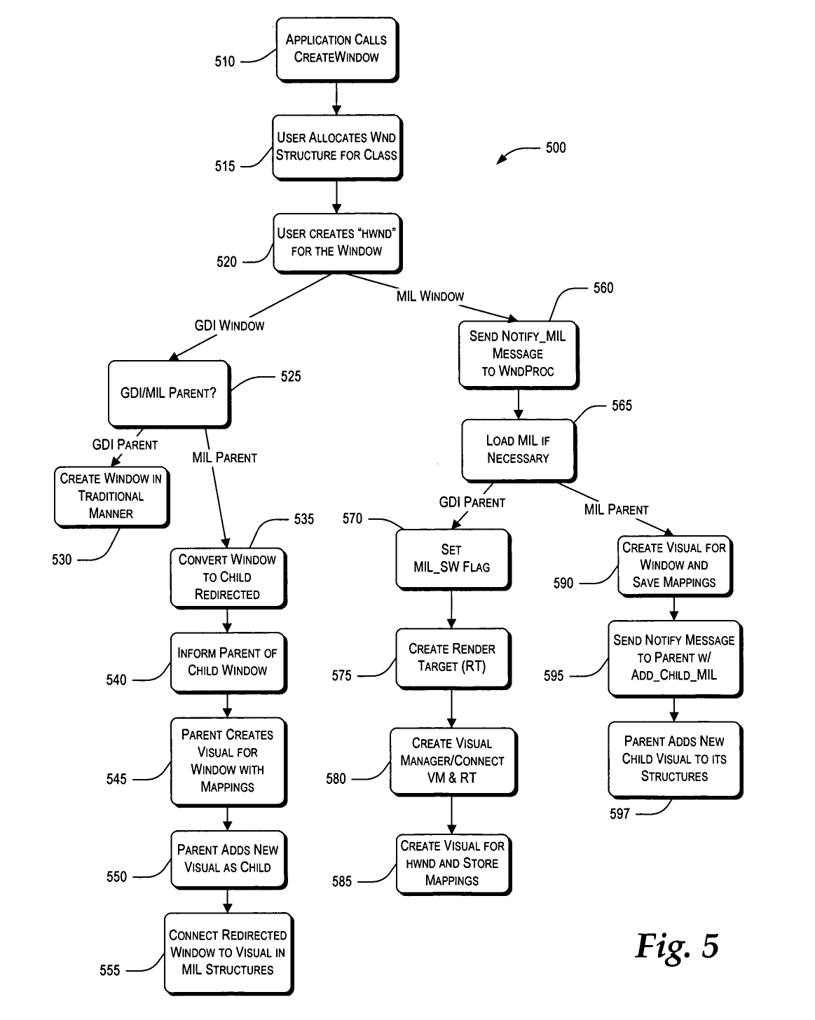

FIGS. 4-5 are logical flow diagrams generally illustrating processes performed to achieve window interoperability in mixed-mode applications. To begin, FIG. 4 is a logical flow diagram generally illustrating operations performed by a process 400 for creating a top-level window in a mixed-mode system such as that described above. The process 400 begins when an application issues a call to create an instance of a window based on a particular window class at step 410.

In response to the call, at step 415, the user component allocates a window structure (e.g., a window object) based on the identified window class. In addition, at step 420, the user component creates a window handle (e.g., an “HWND”) that identifies the window structure. If the window is an immediate-mode window (e.g., a GDI window), at step 425, the user completes the creation and initialization of the window in the traditional manner. In other words, if the first, top-level window created is a GDI window, then there is no need yet to invoke any new-technology mechanisms.

In contrast, at step 430, if the window is a compositional-mode window (e.g., a MIL window), the user component issues a Notify_MIL message and a Create message to a window procedure for the newly created window. The Notify-MIL message has the effect of causing the window to notify the MIL component of its existence, and the Create message has the effect of causing the window to initialize itself.

At step 435, the MIL component is loaded if necessary, i.e., if it isn't already executing. At step 440, the window procedure for the window sets certain flags associated with its status as a MIL window. First, a MIL_HWND flag may be set merely to indicate that the window is a MIL window. In addition, a ML_HW flag may be set to indicate that the window takes advantage of hardware rendering. Since the MIL window is a top level window, setting this flag is appropriate. As will be seen later, if the MIL window is not a top level window, setting the MIL_HW flag will be based on whether it has any non-hardware rendered ancestors, in this implementation. At step 445 the appropriate render target is created (a hardware target in this example).

Then, at step 450, a visual manager is created and connected to the render target just created. A visual manager maintains a “visual tree,” which is a structure that hierarchically represents any MIL graphics content. The visual tree is maintained by the MIL component and invisible to the user component. At step 455, a “visual” is created for the current window, and that visual is set as the root visual for the visual manager created at step 450. A “visual” is a node in the visual tree that can contain child window visuals and graphics content for the window. At step 460, the MIL component stores a mapping of the visual created at step 455 to the window handle (HWND) created at step 420.

FIG. 5 is a logical flow diagram generally illustrating operations performed is by a process 500 for creating a child window in a mixed-mode system. The process 500 begins when an application issues a call to create an instance of a window based on a particular window class at step 510.

In response to the call, at step 515, the user component allocates a window structure (e.g., a window object) based on the identified window class. In addition, at step 520, the user component creates a window handle (e.g., an “HWND”) that identifies the window structure. Unlike the process described above, the window being created here is a child window. Accordingly, if the current window is an immediate-mode window (e.g., a GDI window), at step 525, a determination is made whether the current window's parent is also a GDI window. If so, then at step 530, the user component completes the creation and initialization of the window in the traditional manner. In other words, if there are no non-GDI windows in the parentage of the current window, then there is no need yet to invoke any new-technology mechanisms.

However, if at step 525 it is determined that the parent is a compositional mode window (e.g., a MIL window), then, at step 535 the current window is adapted for use and management by the MIL component. In one example, the current window may be treated as a “child redirected window” and rendered off screen for further manipulation by the MIL component prior to final display. For more information on child redirected windows, see co-pending U.S. patent application Ser. No. 10/692,322, entitled CHILD WINDOW REDIRECTION, and filed on Oct. 23, 2003.

At step 540, a Notify message and an Add_Child_Redirected message may be issued to the parent of the current window. These messages serve the purpose of notifying the current window's parent of the existence and relationship of the current window.

At step 545, the parent window (a MIL window) creates a child “visual” associated with the child window just created. The parent includes any appropriate mappings of the window handle (created at step 520) to the new child visual. At step 550, the parent adds the new child visual to its visual tree, and, at step 555, connects the new child visual with the redirected child window created at step 535.

Returning to step 520, if the current window is a MIL window, at step 560, a Notify_MIL message and a Create message are sent to the current window's window procedure. In response, at step 565, the window procedure loads the MIL component if necessary. If the current window's parent is a GDI window, then, at step 570, the current window's flags are set to indicate that the render target for the current window is a software render target, and, at step 575, the associated software render target is created. Then, at step 580, a visual manager is created and connected to the software render target. At step 585, a visual is created for the current window, and that visual is set as the root visual for the visual manager created at step 580.

Returning to step 565, if the current window's parent is a MIL window, then, at step 590, a visual is created for the window and it is mapped to the as HWND created at step 520. Then at step 595, a Notify message and an Add_Child_MIL message are sent to the current window's parent, causing it to add the current window to its visual tree. Finally, at step 597, the parent window creates and adds the child visual to its (the parent's) visual tree. In addition, the child window takes the hardware-render flag setting of the parent window. In other words, if the parent window has its flag set for hardware rendering, then the child window takes that setting.

Illustrative Computing Environment

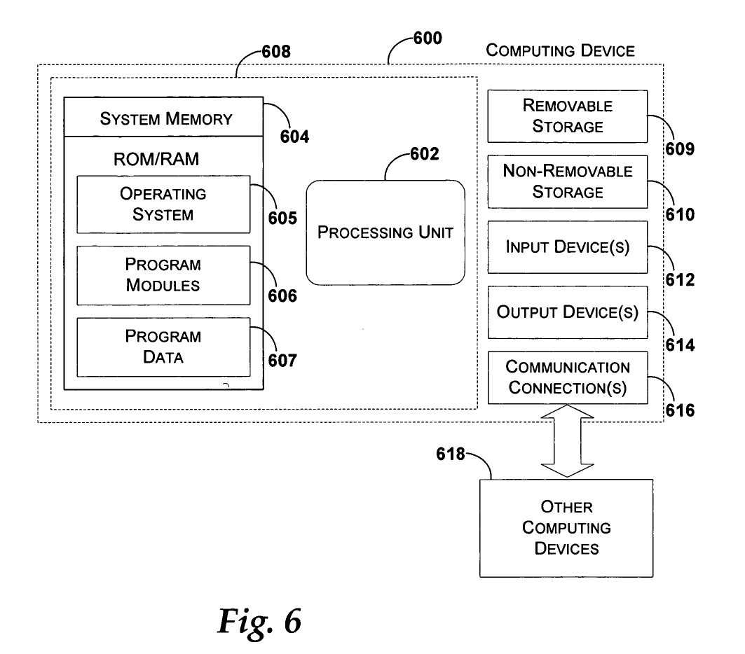

FIG. 6 is a functional block diagram illustrating an exemplary computing device that may be used in embodiments of the methods and mechanisms described in this document. In a very basic configuration, computing device 600 typically includes at least one processing unit 602 and system memory 604. Depending on the exact configuration and type of computing device, system memory 604 may be volatile (such as RAM), non-volatile (such as ROM, flash memory, etc.) or some combination of the two. System memory 604 typically includes an operating system 605, one or more program modules 606, and may include program data 607. This basic configuration is illustrated in FIG. 6 by those components within dashed line 608.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by removable storage 609 and non-removable storage 610. Computer storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media may be part of device 600. Computing device 600 may also have input device(s) 612 such as keyboard, mouse, pen, voice input device, touch input device, etc. Output device(s) 614 such as a display, speakers, printer, etc. may also be included. These devices are well know in the art and need not be discussed at length here.

Computing device 600 may also contain communication connections 616 that allow the device to communicate with other computing devices 618, such as over a network. Communication connections 616 are one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Although details of specific implementations and embodiments are described above, such details are intended to satisfy statutory disclosure obligations rather than to limit the scope of the following claims. Thus, the invention as defined by the claims is not limited to the specific features described above. Rather, the invention is claimed in any of its forms or modifications that fall within the proper scope of the appended claims, appropriately interpreted in accordance with the doctrine of equivalents.

1. A system for enabling interoperability between two graphics technologies, comprising:
a first graphics system configured to render window content in a first mode, the first graphics system being further configured to reference a first type of window using a token associated with an instance of the first type of window;
a second graphics system configured to render windows in a second mode, the second graphics system being further configured to reference a second type of window without a need for the token used by the first graphics system; and
an interoperability component configured to cause a dummy token to be created for an instance of a window of the second type and to use the dummy token if called to perform a graphics related action on the instance of the window of the second type.

2. The system recited in claim 1, further comprising an application program including a first window and a second window, the first window being of the first type and the second window being of the second type.

3. The system recited in claim 2, wherein the first mode comprises a compositional mode of graphics technology.

4. The system recited in claim 2, wherein the second mode comprises an immediate mode of graphics technology.

5. The system recited in claim 1, wherein the token comprises a window handle.

6. The system recited in claim 1, wherein the second graphics system is configured to create a mapping from the token to a node in an internal construct used by the second graphics system to manage windows of the second type.

7. The system recited in claim 6, wherein the internal construct comprises a visual tree, and the node comprises a visual.

8. The system recited in claim 1, wherein the second graphics system is further configured to create a render target for receiving rendered window content.

9. The system recited in claim 8, wherein the render target resides in system memory.

10. The system recited in claim 8, wherein the render target resides in video memory.

11. The system recited in claim 8, wherein the render target records rendering commands generated for windows of the second type and that are played back during composition to generate display output.

12. A computer-readable medium having computer executable components for enabling interoperability between two graphics technologies, comprising:
an interoperability component that interfaces with an application program, the application program including a first window and a second window, the first window being compatible with a first graphics system that uses tokens to reference windows, the second window being compatible with a second graphics system that does not rely on the tokens; and
a mock token associated with the second window, the mock token indicating that the second window is compatible with the second graphics system.

13. The computer-readable medium recited in claim 12, further comprising a mapping, maintained by the second graphics system, from the mock token to a node in an internal construct used by the second graphics system to manage the second window.

14. The computer-readable medium recited in claim 13, wherein the internal construct comprises a visual tree, and the node comprises a visual.

15. The computer-readable medium recited in claim 12, wherein the second graphics system is further configured to create a render target for receiving rendered window content.

16. The computer-readable medium recited in claim 15, wherein the render target comprises a software render target.

17. The computer-readable medium recited in claim 15, wherein the render target comprises a hardware render target.

18. The computer-readable medium recited in claim 15, wherein the render target records rendering commands generated for the second window and that are played back during composition to generate display output.

19. The computer-readable medium recited in claim 12, wherein the mock token is associated with a device context associated with the second window.

20. The computer-readable medium recited in claim 19, wherein the device context comprises a null device context.

21. A computer-implemented method for enabling interoperability between two graphics technologies, comprising:
receiving a request to create a new window;
determining if the new window is of a type associated with an alternative graphics system;
if so, creating a token for the new window;
creating a new visual to be created in connection with the new window, the visual being a construct associated with the alternative graphics system; and
associating the token with the new visual.

22. The computer-implemented method recited in claim 21, wherein if the new window is not of the type associated with the alternative graphics system, rendering the window in accordance with a conventional graphics system.

23. The computer-implemented method recited in claim 21, further comprising receiving an instruction to render display content to the new window referenced by the token, looking up the new visual based on the association between the token and the new visual, and rendering the display content to the new visual.

24. The computer-implemented method recited in claim 23, wherein rendering the display content to the new visual further comprises issuing rendering commands to a render target associated with the new visual.

25. The computer-implemented method recited in claim 24, wherein the render target comprises a software render target.

26. The computer-implemented method recited in claim 24, wherein the render target comprises a hardware render target.

27. The computer-implemented method recited in claim 24, wherein the render target records rendering commands generated for the new window that are played back during composition to generate display output.

28. A computer-readable medium encoded with computer-executable instructions for performing the method of claim 21.
